(19) United States
(12) Patent Application Publication
(10) Pub. No.: US 2010/0247909 A1
(43) Pub. Date: Sep. 30, 2010

(54) Manufacturing process of porous carbon nanofiber using a volatile organic matter

(75) Inventors: Younghee Lee, Suwon (KR); Kayhyeok An, Suwon (KR); Eunju Ra, Suwon (KR)

Correspondence Address: Edwards Angell Palmer & Dodge LLP, P.O. Box 55874, Boston, MA, 02205, US

(73) Assignee: Sungkyunkwan University Foundation for Corporate Collaboration, Suwon (KR)

(21) Appl. No.: 11/647,863

(22) Filed: Dec. 29, 2006

(30) Foreign Application Priority Data
Dec. 31, 2005 (KR) 10-2005-0136237

(51) Int. Cl. D02G 3/02; D01F 9/12; B29C 47/36

(52) U.S. Cl. 428/367; 423/447.2; 264/433; 977/700

(57) ABSTRACT

The present invention provides a process for manufacturing a carbon nanofiber comprising: (a) mixing a carbon nanofiber precursor and camphor in a solvent to prepare a solution; (b) electric spinning the solution to obtain a nanofiber; (c) oxidative stabilizing the nanofiber; and (d) carbonizing the oxidative stabilized nanofiber, wherein camphor is volatilized to form micropores in the oxidative stabilization and carbonization. The present invention also provides a carbon nanofiber manufactured by the same.

### CROSS-REFERENCE TO RELATED APPLICATION

The present application claims, under 35 U.S.C. §119(a), the benefit of the filing date of Korean Patent Application No. 10-2005-0136237 filed on Dec. 31, 2005, the entire contents of which are hereby incorporated by reference.

### BACKGROUND OF THE INVENTION

1. Field of the Invention

The present invention relates to a process for manufacturing a porous carbon nanofiber only by heat treatment using camphor, a volatile compound, without taking an activation step and the carbon nanofiber manufactured thereby.

2. Background Art

Conventionally, a carbon nanofiber has been manufactured by a method such as electric spinning, laser vapor deposition, plasma chemical gas phase vapor deposition, thermochemical vapor deposition, gas phase synthesis and the like. Of these, in the electric spinning method, after carbon nanofiber precursor material is dissolved in an organic solvent, a high voltage is applied between the jet nozzle of a syringe and the collector to continuously form a carbon nanofiber precursor in the dispersed state, and nanofiber is collected in the form of non-wovens in the collector. Since the thus-obtained fiber has a thermoplastic property, it is impossible to be heat-treated at a high temperature, higher than the melting point of the precursor material. To prepare a thermosetting fiber, infusible stabilized fiber is obtained through an oxidative stabilization process and it is subject to a carbonization process at a temperature of from 500° C. to 1500° C. to obtain a carbon nanofiber. The electric spinning method can manufacture a carbon nanofiber with a diameter of less than 1 μm while a solution spinning or melt spinning method can manufacture a carbon fiber with a diameter of 10 to 20 μm.

In order to manufacture a conventional carbon nanofiber, after oxidative stabilization, a gas containing water vapor, carbon dioxide, air and so on is passed and an activation process at a temperature of from 500° C. to 1500° C. is performed. Alternatively, after carbonization at a high temperature, KOH or NaOH is mixed before a chemical activation process at a high temperature is performed.

However, in case of performing the activation process using a gas containing water vapor, carbon dioxide, air and so on, physical properties of the carbon nanofiber can vary depending on the contents of the water vapor, carbon dioxide, air and so on in the gas and the size of the reaction furnace. In addition, since distribution of such active material contained in the gas is not uniform, process reproducibility decreases.

In the chemical activation process using various salts such as KOH or NaOH, since carbon nanofiber and the salts are sufficiently mixed to be heat-treated, it is difficult to be used in a continuous process and mass production, and an additional process for removal of mixed salts, after activation, is required. Furthermore, as salts, active materials, cause reaction furnace to be corroded after heat treatment. Thus, commercial application is difficult.

### BRIEF SUMMARY OF THE INVENTION

The present invention has been made in an effort to provide an improved process for manufacturing a porous carbon nanofiber by heat treatment using a volatile organic compound without an activation step and a new porous carbon nanofiber prepared by the same.

In one aspect, the present invention provides a process for manufacturing a carbon nanofiber comprising: (a) mixing a carbon nanofiber precursor and camphor in a solvent to prepare a solution; (b) electric spinning the solution to obtain a nanofiber; (c) oxidative stabilizing the nanofiber; and (d) carbonizing the oxidative stabilized nanofiber, wherein camphor is volatilized to form micropores in the oxidative stabilization and carbonization.

Preferably, the camphor content is from 100 to 200 wt % of the carbon nanofiber precursor. Also preferably, the carbon nanofiber precursor is at least one selected from the group consisting of polyacrylonitrile (PAN), cellulose and polyimide (PI). Suitable solvent may include, but not limited to, N,N-dimethylformamide (DMF), N,N-dimethylacetamide, tetrahydrofuran and the like.

In a preferred embodiment, the oxidative stabilization process may comprise a step where nanofiber is heated from a normal temperature to the final temperature of 250° C. to 300° C. at the elevating rate of 0.5° C./min to 2° C./min to obtain an infusible stabilized fiber.

In another aspect, the present invention provides a carbon nanofiber manufactured by the processes described above. Preferably, the size of micropores is from 0.5 nm to 50 nm.

### BRIEF DESCRIPTION OF THE DRAWINGS

These, and other features and advantages of the invention, will become clear to those skilled in the art from the following detailed description of the preferred embodiments of the invention rendered in conjunction with the appended drawings in which like reference numerals refer to like elements throughout, and in which:

FIG. 1 represents a diagram showing an electric radiation apparatus for manufacturing a carbon nanofiber according to a preferred embodiment of the present invention;

FIG. 2 represents a flow chart showing a process for manufacturing a porous carbon nanofiber according to a preferred embodiment of the present invention;

FIGS. 3a and 3b represent microscopic photographs of a carbon nanofiber made of PAN with 200 wt % of camphor added; and

FIGS. 4a and 4b represent a nitrogen adsorption isothermal graph of carbon nanofiber made of PAN with 200 wt % of camphor added and a table analyzing micropores properties calculated by α-s method, respectively.

### DETAILED DESCRIPTION OF THE PREFERRED EMBODIMENTS

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

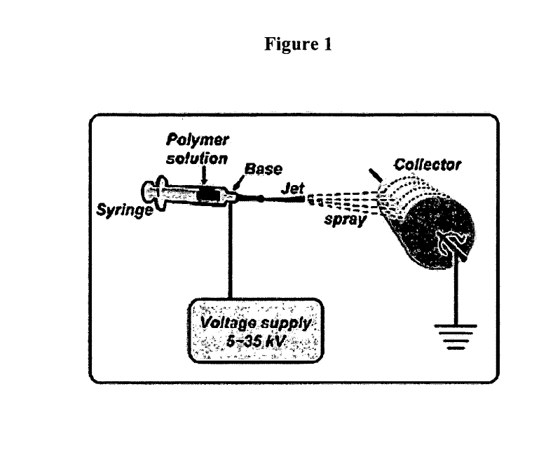

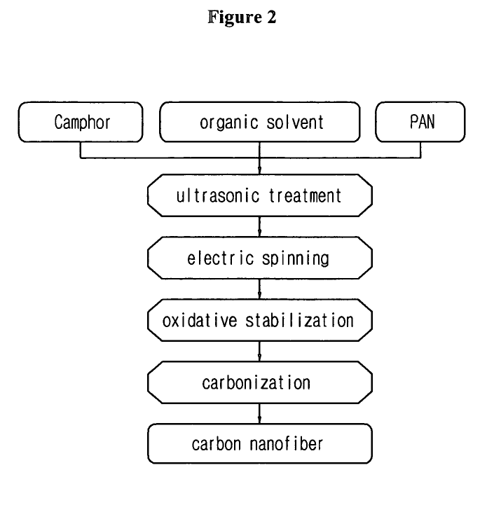

FIG. 1 shows an electric radiation apparatus for manufacturing a carbon nanofiber according to a preferred embodiment of the present invention. FIG. 2 represents a flow chart showing a process for manufacturing a porous carbon nanofiber according to a preferred embodiment of the present invention.

To manufacture a porous carbon nanofiber according to the present invention, a carbon nanofiber precursor for electric spinning, a solvent and camphor are mixed to prepare a polymeric solution. After camphor of 100 to 200 wt % based on polyacrylonitrile as a carbon nanofiber precursor is added to DMF (N,N-dimethylformamide) as a solvent and is dissolved. Polyacrylonitrile as a carbon nanofiber precursor polymer is then added. After these two materials are dissolved in the solvent, they are subject to ultrasonic treatment for 10 to 20 hours so that camphor is uniformly dispersed in polyacrylonitrile, and a polymeric solution is prepared. The polymeric solution is brought to the syringe and fiber is made using the electric spinning apparatus as shown in FIG. 1. High voltage of 5 kV to 35 kV is applied between the jet nozzle and the collector, and the applied voltage is controllable through a voltage device. In a preferred embodiment, 20 kV of voltage is applied through a voltage device. Carbon nanofiber precursor jetted by the jet nozzle is continuously collected as form of nonwovens on the collector. The nanofiber prepared in this way is placed in an electric furnace to which air can be provided to make thermosetting fibers and is heated from a normal temperature to the final temperature of 250° C. to 300° C. at a rate of 0.5° C./min to 2° C./min to obtain an infusible stabilized fiber through an oxidative stabilization process.

The thus-prepared thermosetting fiber can be brought through a carbonization process at a temperature of 500° C. to 1500° C. in an inactive atmosphere or in a vacuum state to obtain a carbon nanofiber. Since the temperature of 250° C. to 300° C., which is the final temperature of the oxidative stabilization process, is beyond the boiling point of camphor, which is about 200° C., most of the camphor is released from the nanofiber to form micropores at the surface of the nanofiber. Also, it is surrounded with polyacrylonitrile so that any camphor that has not been released in the oxidative stabilization process and is present in the polyacrylonitrile is all released in the carbonization treatment process at a high temperature, and a carbon nanofiber having micropores at its surface is manufactured.

The diameter of the carbon nanofiber obtained in this way ranges from 50 nm to 300 nm, the specific surface area is 500 m²/g, and the size of the micropores ranges from 0.5 to 50 nm. The specific surface area of carbon nanofiber and the size of the micropores can be adjusted depending on the camphor content and the ultrasonic treatment time.

According to the present invention, a porous carbon nanofiber having various sizes of surface area can be manufactured through an oxidative stabilization process and a carbonization process of nanofiber made by electric spinning method without an activation process.

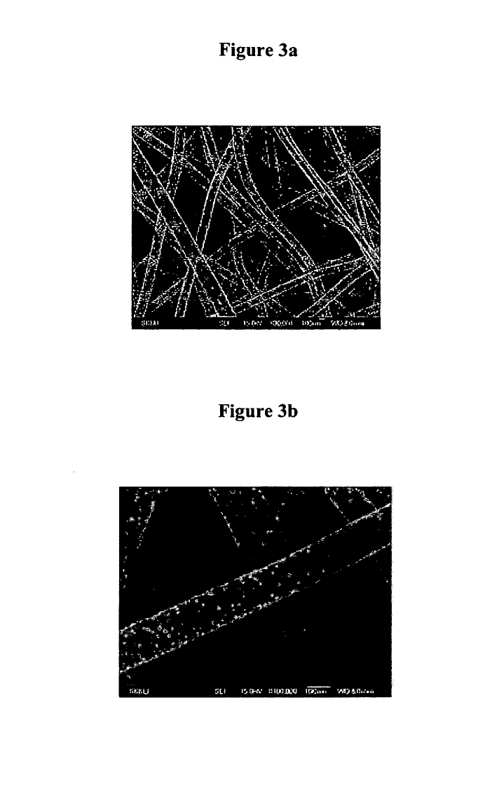

FIGS. 3a and 3b are microscopic photographs of a porous carbon nanofiber after the oxidative stabilization process and carbonization process. The positions of camphor removal can be recognized as those projected in white color, representing less crystallization than other positions. In addition, the white projected part is so uniformly distributed over the surface of the fiber that it can be uniformly carried when used as a catalyst carrier.

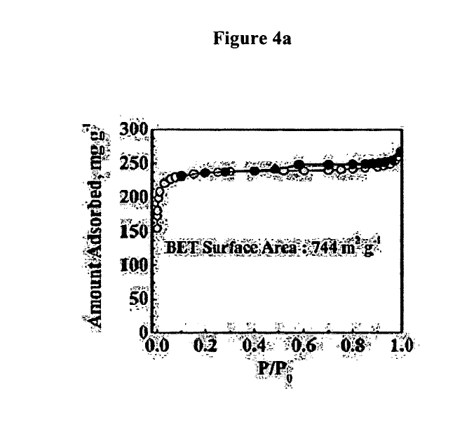

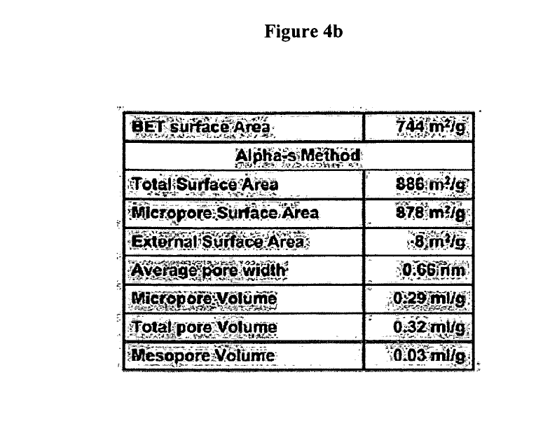

FIG. 4a shows a nitrogen adsorption isothermal graph of the carbon nanofiber manufactured after the oxidative stabilization process and the carbonization process according to the present invention. FIG. 4b represents a table analyzing the properties of the micropores formed in the carbon nanofiber using the α-s method in the case of fiber made of a polymeric solution containing polyacrylonitrile and 200 wt % of camphor.

As described above, according to the preferred embodiments of the present invention, no additional materials required for, for instance, gas activation and chemical activation. Also, since the porous carbon nanofiber is manufactured through carbonization after oxidative stabilization, a continuous process and/or a mass production can be performed. In addition, since camphor removal position is projected in the white color of less crystallization than other positions and is the porous structure uniformly distributed over the whole surface of the fiber, it can be carried uniformly when used as a catalyst carrier. Furthermore, the size and the specific surface area of micropores can be controlled based on the camphor content and the ultrasonic treatment time so that carbon nanofibers having micropores can have specific surface area which is large relative to the volume. As a result, it is applicable to various industrial fields such as supercapacitors, fuel cells, adsorptive materials and the like.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A process for manufacturing a carbon nanofiber comprising:
mixing a carbon nanofiber precursor and camphor in a solvent to prepare a solution;
electric spinning the solution to obtain a nanofiber;
oxidative stabilizing the nanofiber to release the camphor from the nanofiber, thereby forming micropores at the surface of the nanofiber; and
carbonizing the oxidative stabilized nanofiber to release any camphor that has not been released by the oxidative stabilization process, thereby forming further micropores at the surface of the nanofiber.

2. The process according to claim 1, wherein the camphor content is from 100 to 200 wt % of the carbon nanofiber precursor.

3. The process according to claim 1, wherein the carbon nanofiber precursor is at least one selected from the group consisting of polyacrylonitrile (PAN), cellulose and polyimide (PI).

4. The process according to claim 1, wherein the oxidative stabilization comprises heating the nanofiber from a normal temperature to the final temperature of 250° C. to 300° C. at the elevating rate of 0.5° C./min to 2° C./min to obtain an infusible stabilized fiber.

5. A carbon nanofiber manufactured by the process according to claim 1.

6. The carbon nanofiber according to claim 5, wherein the size of micropores is from 0.5 nm to 50 nm.
